(19) United States
(12) Patent Application Publication
(10) Pub. No.: US 2017/0055027 A1
(43) Pub. Date: Feb. 23, 2017

(54) DEVICE AND METHOD FOR PLAYING AUDIOS AND VIDEOS

(71) Applicants: Le Holdings (Beijing) Co., Ltd., Beijing (CN); Le Shi Zhi Xin Electronic Technology (Tian Jin) Limited, Beijing (CN)

(72) Inventor: Wei LIU, Beijing (CN)

(21) Appl. No.: 15/240,854

(22) Filed: Aug. 18, 2016

Related U.S. Application Data
(63) Continuation of application No. PCT/CN2016/083914, filed on May 30, 2016.

(30) Foreign Application Priority Data
Aug. 21, 2015 (CN) 201510520815.7
May 30, 2016 (CN) PCT/CN2016/083914

(51) Int. Cl. H04N 21/4363; H04N 21/41; H04N 21/4402; H04N 7/01

(52) U.S. Cl. CPC H04N 21/43632; H04N 7/0127; H04N 7/0117; H04N 21/4122; H04N 21/43635; H04N 21/440263; H04N 21/43637

(57) ABSTRACT

Disclosed are a device and a method for playing audios and videos. The device for playing audios and videos includes a smart TV system-on-chip, a processor and a video format conversion bridge chip, wherein the smart TV system-on-chip is configured to receive audio and video signals and decode the audio and video signals; the processor receives the decoded audio and video signals and converts video signals in the decoded audio and video signals into first data format video signals; and the video format conversion bridge chip receives and converts the first data format video signals into second data format video signals, and provides the signals to a display screen to play, thus enabling the device for playing audios and videos to both have high-definition frames and the function of being suitable for executing large-scale software, so as to improve the user experience and willingness to use.

### CROSS-REFERENCE TO RELATED APPLICATIONS

This application is a continuation of International Application No. PCT/CN2016/083914, filed on May 30, 2016, which is based upon and claims priority to Chinese Patent Application No. 201510797405.7, filed on Aug. 21, 2015, the entire contents of which are incorporated herein by reference.

### TECHNICAL FIELD

The disclosure relates to the field of multimedia technologies, and more particularly, to a device and a method for playing audios and videos.

### BACKGROUND

For a solution employed to execute audio and video playing functions, currently a device for playing audios and videos (such as a smart TV) can only meet the use demand of playing a video or playing a small game since the processing capacity of a processor thereof is lower. However, for the use demand of executing large-scale games, its processing capacity for large games is far insufficient. Therefore, if gamers want to execute operations of large-scale games through general a device for playing audios and videos, it is required to purchase an additional game machine to execute, such as Microsoft XBOX ONE or Sony PS4 for playing the large-scale games on a smart TV.

Therefore, the current device for playing audios and videos cannot comply with the use demand for one machine multi-purpose, and additional a device is needed, which merely increases the cost, thus resulting in poor user experience so as to reduce their willingness to use the device for playing audios and videos.

### SUMMARY

The present invention provides a device and a method for playing audios and videos which are configured to solve the problems in the related art that the use demand for one machine multi-purpose cannot be satisfied, which results in poor user experience and the willingness to use the device for playing audios and videos is reduced.

In order to implement the foregoing objects, the embodiments of the present application employ the following technical solutions.

According to a first aspect, it provides a device for playing audios and videos, including a smart TV system-on-chip, a processor and a video format conversion bridge chip. Wherein, the smart TV system-on-chip is configured to receive audio and video signals, decode the audio and video signals, and then transmit the signals to the processor; the processor is coupled to the smart TV system-on-chip and the video format conversion bridge chip respectively, and the processor is configured to receive the decoded audio and video signals and convert video signals in the decoded audio and video signals into first data format video signals, and transmit the first data format video signals to the video format conversion bridge chip; and the video format conversion bridge chip is coupled to the processor and a display screen for receiving the first data format video signals and converting the first data format video signals into second data format video signals, and transmitting the second data format video signals to the display screen.

According to a second aspect, it provides a method for playing audios and videos, including:
receiving audio and video signals, and decoding the audio and video signals;
converting video signals in the decoded audio and video signals into first data format video signals;
converting the first data format video signals into second data format video signals; and
displaying the second data format video signals.

According to a third aspect, it provides a non-volatile computer readable storage medium, where the non-volatile computer readable storage medium stores a computer instruction, and a computer executes the computer instruction to execute the following operations: receiving audio and video signals, and decoding the audio and video signals; converting video signals in the decoded audio and video signals into first data format video signals; converting the first data format video signals into second data format video signals; and displaying the second data format video signals.

The device for playing audios and videos provided by the embodiment of the present invention, for example, a smart TV, is suitable for processing audio and video signals in different data formats such as the audio and video signals in the data formats of HDMI, analog, digital, component, AV, tuner or CVBS through the configuration of the smart TV system-on-chip, and decodes the audio and video signals, and then transmits the signals to the processor for subsequent processing. Meanwhile, the video signals received by the device for playing audios and videos are suitable to be played on the display screen through the configuration of the high-performance processor having performance indexes apparently higher than that of a general processor, and converting the data format of the video signals of the main signal source by the video format conversion bridge chip, so that the device for playing audios and videos not only can provide a high-quality video viewing function, but also has the efficacy of executing high power consumption software. Therefore, for the aspect of use, the device for playing audios and videos enables users to view high-quality videos, and can also meet the use demand for executing large-scale games at the same time, so that the entire audio-visual entertainment efficacy of the device for playing audios and videos is enhanced, the user experience is improved, and the cost for additionally purchasing a game machine is saved.

### BRIEF DESCRIPTION OF THE DRAWINGS

In order to explain the technical solutions in the embodiments of the present invention or in the prior art more clearly, the drawings used in the descriptions of the embodiments or the prior art will be simply introduced hereinafter. It is apparent that the drawings described hereinafter are merely some embodiments of the present invention, and those skilled in the art may also obtain other drawings according to these drawings without going through creative work.

FIG. 1 is a block diagram of a first embodiment of a device for playing audios and videos according to the present invention;

FIG. 2 is a block diagram of a second embodiment of the device for playing audios and videos according to the present invention;

FIG. 3 is a block diagram of a third embodiment of the device for playing audios and videos according to the present invention; and

FIG. 4 is a flow chart of a first embodiment of a method for playing audios and videos according to the present invention.

### DETAILED DESCRIPTION

To make the objects, technical solutions and advantages of the embodiments of the present invention more clearly, the technical solutions of the present invention will be clearly and completely described hereinafter with reference to the embodiments and drawings of the present invention. Apparently, the embodiments described are merely partial embodiments of the present invention, rather than all embodiments. Other embodiments derived by those having ordinary skills in the art on the basis of the embodiments of the present invention without going through creative efforts shall all fall within the protection scope of the present invention.

The technical solutions provided by each embodiment of the present invention will be described in details with reference to the drawings hereinafter.

The device for playing audios and videos and/or a device for outputting audios and videos disclosed by the embodiments of the present invention is configured to transmit the video signals to the display screen, wherein the device for playing audios and videos may be, but is not limited to a TV set, such as a smart TV, while the device for outputting for audios and videos may be such a video and audio apparatus like a DVD player or a set top box externally connected to the device for playing audios and videos. The above is exemplary and explanatory only, and is not intended for limitation.

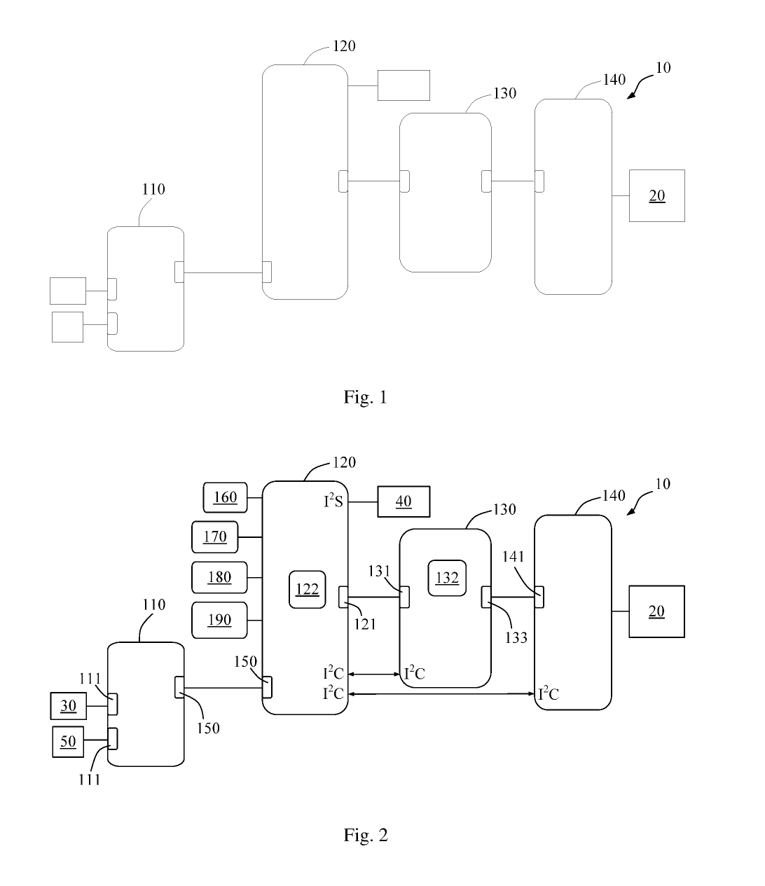

Please refer to FIG. 1. A device for playing audios and videos 10 disclosed by a first embodiment of the present invention includes a smart TV system-on-chip (TVSOC) 110, a processor 120 and a video format conversion bridge chip 130. Wherein, the smart TV system-on-chip 110 is configured to receive audio and video signals, decode the audio and video signals and then transmits the decoded audio and video signals to the processor, wherein the audio and video signals may be the main audio and video signals of a TV signal source, a signal source from internet or a signal source downloaded from a local end; or the external audio and video signals from such external signal source as a DVD player or a set top box. The processor 120 is a processor having a master frequency and a register bit higher than that of a general processor. For example, if the general processor has 32 bits and a master frequency of 1.2 GHz, then the processor 120 may be a 64-bit processor having a master frequency of 2-2.5 GHz, but is not limited to this. The processor 120 is coupled to the smart TV system-on-chip 110 and the video format conversion bridge chip 130 respectively, and the processor 120 is configured to receive the decoded audio and video signals and convert video signals in the decoded audio and video signals into first data format video signals, and transmit the first data format video signals to the video format conversion bridge chip 130; and the video format conversion bridge chip 130 is coupled to the processor 120 and a display screen 20 for receiving the first data format video signals and converting the first data format video signals into second data format video signals, and transmitting the second data format video signals to the display screen 20.

Wherein, when the smart TV system-on-chip 110 of the device for playing audios and videos 10 receives the audio and video signals from a main signal source 30 or an external signal source 50, the smart TV system-on-chip 110 decodes the audio and video signals firstly and then transmits the decoded audio and video signals to the processor 120. The processor 120 receives and converts the data format of the decoded audio and video signals, for example, selectively converts the data format of the decoded video signals into first data format video signals in HDMI according to the actual demands, so that the video signals in the decoded audio and video signals are suitable to be received by the video format conversion bridge chip 130.

The video format conversion bridge chip 130 after receiving the first data format video signals, converts the data format of the first data format video signals from HDMI into the second data format video signals, for example, the video signals in V-by-One, and then transmits the second data format video signals to the display screen 20 to play.

Based on the above descriptions, in the device for playing audios and videos of the present invention, the configuration of the smart TV system-on-chip 110 enlarges the sources and types of the audio and video signals that can be received by the processor; meanwhile, the device for playing audios and videos is enabled to possess the ability of processing large-scale software, for example, large-scale games or other high power consumption software, through a manner of configuring the processor having performance indexes apparently higher than that of a general processor; moreover, the video signals received by the processor can be played on the display screen through converting the data format of the video signals by the video format conversion bridge chip, thus improving the smoothness and quality of the display frame, and increasing the user experience at the same time.

Please refer to FIG. 2. A device for playing audios and videos 10 disclosed by a second embodiment of the present invention is coupled with a main signal source 30, an audio system 40 and a display screen 20, wherein the main signal source 30 may be, but is not limited to a TV signal source, a signal source from internet or a signal source downloaded from a local end, while the audio system 40 and the display screen 20 may be, but are not limited to multimedia devices self-provided by the device for playing audios and videos 10, or multimedia devices externally connected to the device for playing audios and videos 10 in a detachable form. In addition, when such a device for outputting for audios and videos as a DVD player or a set top box is plugged in the device for playing audios and videos 10 to mutually couple with each other, the device for playing audios and videos 10 may enable the device for outputting for audios and videos to be served as an external signal source 50 so as to receive the audio and video signals from the device for outputting for audios and videos to play audios and/or videos.

The device for playing audios and videos 10 includes a smart TV system-on-chip (TVSOC) 110, a processor 120, a video format conversion bridge chip 130 and a motion compensation frame rate converter 140, wherein an audio and video signal input interface 111 is electrically set on the smart TV system-on-chip 110, for example, any one of such signal source input interfaces as a high definition multimedia interface (High Definition Multimedia Interface, hereinafter referred to as HDMI), an analog signal input interface, a digital signal input interface, a component input interface, an AV input interface, a tuner input interface, a composite video baseband signal (Composite Video Baseband Signal, CVBS) input interface or the like; and the combinations of the foregoing interfaces. Moreover, the smart TV system-on-chip 110 is coupled to the main signal source 30 and/or the external signal source 50 through the audio and video signal input interface 111 to facilitate receiving the audio and video signals from the main signal source 30 and/or external signal source 50, decoding the audio and video signals and then transmitting the decoded audio and video signals to the processor 120, wherein the smart TV system-on-chip 110 may be, but is not limited to be coupled to the processor 120 through a universal serial bus (Universal Serial Bus, hereinafter referred to as USB), for example, the smart TV system-on-chip 110 and the processor 120 are provided with corresponding USB interfaces 150, which are preferably USB3.1 interfaces, respectively, and are mutually connected through a USB connecting wire, so that the smart TV system-on-chip 110 may transmit 4K*2K video data to the processor 120.

The processor 120 is a processor having a master frequency and a register bit higher than that of a general processor. For example, if the general processor has 32 bits and a master frequency of 1.2 GHz, then the processor 120 may be a 64-bit processor having a master frequency of 2-2.5 GHz, wherein this is a relative value, and any processor having performance indexes apparently higher than that of a general processor (i.e., so-called high-performance processor) is applicable to be served as the processor 120 of the device for playing audios and videos 10 in the embodiment of the present invention.

A first video format output interface 121 and a processing module 122 are electrically set on the processor 120, wherein the processing module 122 includes a central processing unit (central processing unit, CPU) and/or a graphic processing unit (graphic processing unit, GPU). While the first video format output interface 121 may be, but is not limited to one of a mobile high-definition video-audio standard interface (mobile high-definition link, MHL; hereinafter referred to as MHL interface), an HDMI interface, a low voltage differential signaling (Low Voltage Differential Signaling, LVDS) interface, a DP interface (display port), an EDP interface (Embedded Display Port), an MIPI DSI interface (Mobile Industry Processor Interface-Display Serial Interface, mobile industry processor and display serial interface) and combinations thereof, and the processor 120 is namely coupled to the corresponding interface on the video format conversion bridge chip 130 through the first video format output interface 121.

Furthermore, the processor 120 is also coupled to the video format conversion bridge chip 130 and the motion compensation frame rate converter 140 respectively through an inter-integrated circuit (Inter-Integrated Circuit, I2C) bus; and is coupled to the audio system 40 through an I2S (Inter-IC Sound) audio system 40 (also called as integrated circuit built-in audio bus). Therefore, the processor 120 may receive the decoded audio and video signals from the smart TV system-on-chip 110, and transmit the decoded audio and video signals to the audio system 40; and convert the data format of the video signals in the decoded audio and video signals, so that the video signals are converted into the first data format video signals, for example, video signals in HDMI, to facilitate conforming to the signal transmission format between the processor 120 and the video format conversion bridge chip 130, and then the first data format video signals are transmitted to the video format conversion bridge chip 130 through the first video format output interface 121.

Wherein, the processor 120 is also coupled to an Ethernet module 160, a wireless communication module 170, a power management module 180 and a memory module 190 configured in the device for playing audios and videos 10 respectively, and may obtain audio and video signals from the Ethernet module 160, the wireless communication module 170 or the memory module 190, and these audio and video signals may also be served as the audio and video signals of another main signal source, for example: audio and video signals received by such wireless or wired communication modes like the Ethernet module 160 or the wireless communication module 170; or audio and video data directly read from the memory module 190, and audio and video signals directly provided by the device for playing audios and videos 10 itself. Moreover, the audio signals in these audio and video signals are transmitted to the audio system 40 and the video signals in these audio and video signals are transmitted to the video format conversion bridge chip 130.

A first video format input interface 131, a micro control unit (micro control unit, MCU) 132 and a second video format output interface 133 are electrically set on the video format conversion bridge chip 130. The first video format input interface 131 is coupled to the first video format output interface 121 of the processor 120 for receiving the first data format video signals from the processor 120. While the second video format output interface 133 is coupled to a second video format input interface 141 electrically set on the motion compensation frame rate converter 140, for transmitting the video signals (i.e., the second data format video signals) to the motion compensation frame rate converter 140 after the data format of the first data format video signals is converted by the video format conversion bridge chip 130.

Wherein, the data format of the first video format input interface 131 of the video format conversion bridge chip 130 is the same as the data format of the first video format output interface 121 of the processor 120, for example, both of the two are HDMI; the data format of the second video format output interface 133 of the video format conversion bridge chip 130 is different from the data format of the first video format output interface 121 of the processor 120, for example, the data format is V-by-One. It is to be understood that because the second video format output interface 133 of the video format conversion bridge chip 130 and the second video format input interface 141 of the motion compensation frame rate converter 140 are a video signal output interface and a video signal input interface with corresponding data format, the data format of the second video format input interface 141 of the motion compensation frame rate converter 140 in the embodiment is also V-by-One.

Besides being coupled to the video format conversion bridge chip 130, the motion compensation frame rate converter 140 is also coupled to the display screen 20 for receiving the second data format video signals from the video format conversion bridge chip 130, and conducting frame rate conversion (frame rate conversion, FRC) on the second data format video signals based on motion estimation and motion compensation (motion estimation and motion compensation, MEMC) principle, so as to process the second data format video signals into high resolution and high frame rate video signals, for example, improve the video contents with a common refresh rate of 60 Hz to video contents with a refresh rate of 120 Hz or 240 Hz, and then transmit the high resolution and high frame rate video signals to the display screen 20 to play, thus improving the definition of motion pictures.

The operation mode of the device for playing audios and videos 10 disclosed by the second embodiment of the present invention will be illustrated hereinafter through a specific implementation manner.

Wherein, when the smart TV system-on-chip 110 of the device for playing audios and videos 10 receives the audio and video signals from a main signal source 30 or an external signal source 50, the smart TV system-on-chip 110 decodes the audio and video signals firstly and then transmits the decoded audio and video signals to the processor 120 through a USB interface 150. The processor 120 receives and converts the data format of the decoded audio and video signals, to enable the audio signals in the decoded audio and video signals suitable to be transmitted to the audio system 40, and enable the video signals in the decoded audio and video signals suitable to be transmitted to the video format conversion bridge chip 130, wherein the processor 120 transmits the audio signals in the audio and video signals to the audio system 40 through an I2S audio bus; and after the video signals in the decoded audio and video signals are converted into the first data format video signal, the first data format video signals are transmitted to the video format conversion bridge chip 130 through the first video format output interface 121; during this process, the processor 120 selectively converts the data format of the decoded video signals according to the actual demands into the data format suitable for the first video format output interface 121, for example, HDMI, and then transmits the signals to the video format conversion bridge chip 130 through the first video format output interface 121.

It's worth noting that if the data volume received by the smart TV system-on-chip 110 from the external signal source 50 is larger, for example, HDMI2.0 full-bandwidth 18 Gbps, while the bandwidth of the USB3.1 interface arranged on the smart TV system-on-chip 110 and the processor 120 is only 10 Gbps; at this moment, the smart TV system-on-chip 110 may compress the data of the external audio and video signals received firstly, so that the signals satisfy the data of the transmission bandwidth of the USB interface, and then the signals are transmitted to the processor 120, so that the processor 120 decodes the signals and then transmits the audio signals therein to the audio system to play and transmits the video signals data volume therein to the video format conversion bridge chip 130.

The video format conversion bridge chip 130 after receiving the first data format video signals through the first video format input interface 131, converts the data format of the first data format video signals from HDMI into the second data format video signals, for example, the video signals in V-by-One, and then transmits the second data format video signals to the motion compensation frame rate converter 140 through the second video format output interface 133.

Next, after receiving the second data format video signals through the second video format input interface 141, the motion compensation frame rate converter 140 conducts motion estimation, motion compensation and frame rate conversion on the second data format video signals, so that the second data format video signals are processed into high resolution and high frame rate video signals. Then, the high resolution and high frame rate video signals are transmitted to the display screen 20 to play, thus presenting high definition frames on the display screen 20.

Therefore, in the device for playing audios and videos provided by the embodiment of the present invention, the device for playing audios and videos is enabled to possess the ability of processing large-scale software, for example, large-scale games or other high power consumption software, through enlarging the resources and types of the audio and video signals that can be received by the processor through the configuration of the smart TV system-on-chip 110 and through a manner of configuring the processor having performance indexes apparently higher than that of a general processor in the meanwhile. Moreover, the video signals received by the processor can be played on the display screen through converting the data format of the video signals by the video format conversion bridge chip; and high resolution and high frame rate video signals are provided to the display screen through optimizing the converted video signals by the motion compensation frame rate converter, thus improving the quality of the display frame, and increasing the user experience at the same time.

It's worth noting that in the device for playing audios and videos of the present invention, if the processor is closer to the video format conversion bridge chip and long-distance signal wire routing is not needed, or the motion compensation frame rate converter is not used, the function of the motion compensation frame rate converter may be closed, or the configuration of the motion compensation frame rate converter may be omitted.

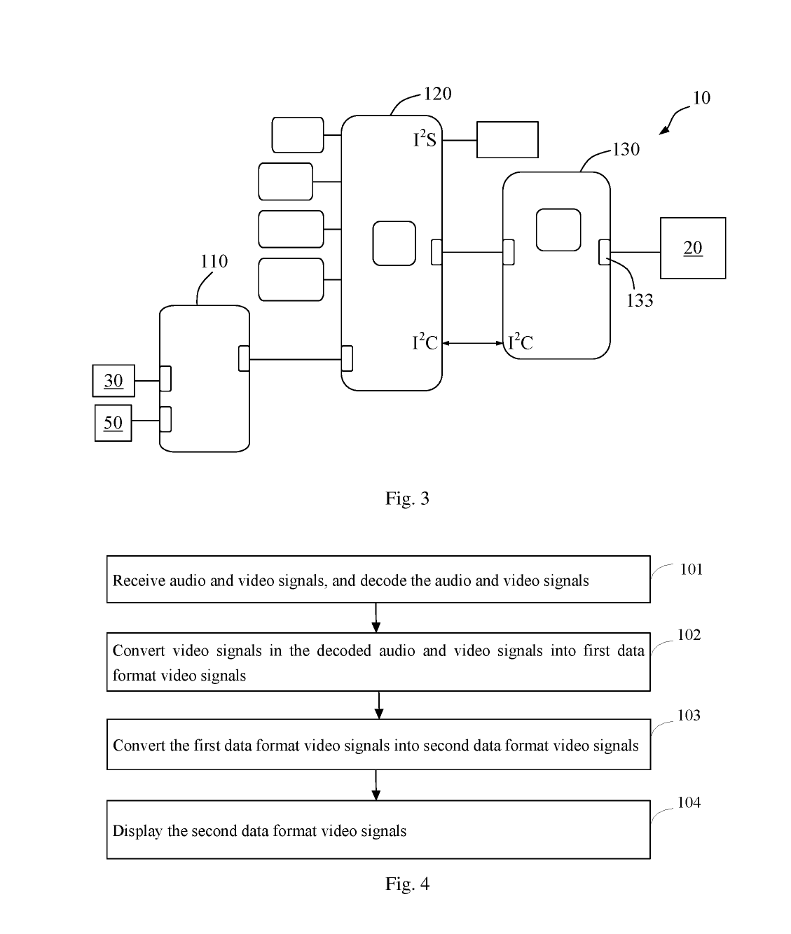

FIG. 3 is a block diagram of a third embodiment of the device for playing audios and videos according to the present invention. The third embodiment disclosed by the present invention is approximately the same as the second embodiment in entire architecture, while the differences between the two lie in that the device for playing audios and videos 10 disclosed by the third embodiment of the present invention includes a smart TV system-on-chip 110, a processor 120 and a video format conversion bridge chip 130, wherein the smart TV system-on-chip 110 is coupled to a main signal source 30 and/or an external signal source 50, the processor 120 is coupled between the smart TV system-on-chip 110 and the video format conversion bridge chip 130, while the video format conversion bridge chip 130 is coupled to a display screen 20 through a second video format output interface 133. Therefore, when audio and video signals from a main signal source 30 and/or an external signal source 50 are decoded by the smart TV system-on-chip 110, and when the video signals therein are converted into first data format video signals by the processor 120, the first data format video signals are converted into second data format video signals through the video format conversion bridge chip 130, and are directly transmitted to the display screen 20 to play, thus omitting high resolution and high frame rate processing program.

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

FIG. 4 is a flow chart of a first embodiment of a method for playing audios and videos according to the present invention. As shown in FIG. 1, the method includes the following steps.

In step 101, audio and video signals are received, and the audio and video signals are decoded.

In step 102, video signals in the decoded audio and video signals are converted into first data format video signals.

In step 103, the first data format video signals are converted into second data format video signals.

In step 104, the second data format video signals are displayed.

The method for playing audios and videos provided by the embodiment may be implemented with reference to the descriptions in the embodiments as shown in FIG. 1 to FIG. 3, wherein an executive body of the method is the device for playing audios and videos in FIG. 1 to FIG. 3. To be specific, the executive bodies of various steps may be composition members of the device for playing audios and videos, for instance, the smart TV system-on-chip (TVSOC) 110, the processor 120 and the video format conversion bridge chip 130.

Wherein, the audio and video signals may be main audio and video signals from a TV signal source, a signal source from internet or a signal source downloaded from a local end; or external audio and video signals from such external signal source as a DVD player or a set top box.

In practical application, after the receiving and decoding the audio and video signals, the video signals in the decoded audio and video signals may be converted into first data format video signals. For example, the data format of the decoded audio and video signals are selectively converted into first data format video signals in HDMI according to the actual demands, so that the video signals in the decoded audio and video signals are suitable to be received by a subsequent processing device, for example, received by the video format conversion bridge chip 130.

Thereby, the data format of the first data format video signals is converted from HDMI into the second data format video signals, for example, the video signals in V-by-One, and then the second data format video signals are transmitted to a display screen to play, so that the second data format video signals are suitable to be displayed on the display screen.

Based on the above descriptions, in the method for playing audios and videos of the present invention, the sources and types of the audio and video signals that can be received by the processor are enlarged; meanwhile, the device for playing audios and videos is enabled to possess the ability of processing large-scale software, for example, large-scale games or other high power consumption software, through a manner of configuring the processor having performance indexes apparently higher than that of a general processor; moreover, the video signals received by the processor can be played on the display screen through converting the data format of the video signals by the video format conversion bridge chip, thus improving the smoothness and quality of the display frame, and increasing the user experience at the same time.

Optionally, the device for playing audios and videos may also be externally connected with an audio system, as shown in FIG. 2. The audio and video signal besides the video signals may also include audio signals. Therefore, optionally, after the audio and video signals are received, the audio signals in the audio and video signals may be decoded, and the audio signals in the decoded audio and video signals are played through an audio system 1.

Optionally, the method, before the displaying the second data format video signals in step 104, may further include:

The second data format video signals are processed as high resolution and high frame rate video signals. Accordingly, the displaying the second data format video signals includes: displaying the high resolution and high frame rate video signals.

It may be seen from the embodiment that frame rate conversion (frame rate conversion, FRC) is performed on the second data format video signals based on motion estimation and motion compensation (motion estimation and motion compensation, MEMC) principle, so as to process the second data format video signals into high resolution and high frame rate video signals, for example, improve the video contents with a common refresh rate of 60 Hz to video contents with a refresh rate of 120 Hz or 240 Hz, and then transmit the high resolution and high frame rate video signals to the display screen 20 to play, thus improving the definition of motion frames.

Moreover, the embodiment of the present invention also provides a device for playing audios and videos, including:

a processor and a memory, wherein a program is stored in the memory, and the processor is configured to invoke the program stored in the memory to execute the steps in the foregoing method embodiment.

Moreover, the embodiment of the present invention also provides a computer-readable recording medium recording a program configured to execute the program as described in the foregoing method embodiment.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present invention, but are not intended to limit the present invention. Although the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. A device for playing audios and videos, comprising: a smart TV system-on-chip, a processor and a video format conversion bridge chip, wherein,
the smart TV system-on-chip is configured to receive audio and video signals, decode the audio and video signals, and then transmit the signals to the processor;
the processor is coupled to the smart TV system-on-chip and the video format conversion bridge chip respectively, and the processor is configured to receive the decoded audio and video signals and convert video signals in the decoded audio and video signals into first data format video signals, and transmit the first data format video signals to the video format conversion bridge chip; and
the video format conversion bridge chip is coupled to the processor and a display screen for receiving the first data format video signals and converting the first data format video signals into second data format video signals, and transmitting the second data format video signals to the display screen.

2. The device for playing audios and videos according to claim 1, wherein an audio and video signal input interface that is coupled to a main signal source and/or an external signal source is electrically set on the smart TV system-on-chip, and the audio and video signals are inputted into the smart TV system-on-chip through the audio and video signal input interface.

3. The device for playing audios and videos according to claim 1, further comprising:
a motion compensation frame rate converter coupled between the video format conversion bridge chip and the display screen for receiving and processing the second data format video signals into high resolution and high frame rate video signals, and transmitting the high resolution and high frame rate video signals to the display screen.

4. The device for playing audios and videos according to claim 3, wherein,
the smart TV system-on-chip is coupled to the processor through a universal serial bus, and a first video format output interface which is coupled to the video format conversion bridge chip is electrically set on the processor;
a first video format input interface and a second video format output interface are electrically set on the video format conversion bridge chip, the first video format input interface is coupled to the first video format output interface, and the second video format output interface is coupled to the motion compensation frame rate converter; and
a second video format input interface which is coupled to the second video format output interface is electrically set on the motion compensation frame rate converter.

5. The device for playing audios and videos according to claim 4, wherein the audio and video signal input interface is any one of an HDMI, an analog signal input interface, a digital signal input interface, a component input interface, an AV input interface, a tuner input interface, a CVBS input interface and combinations thereof.

6. The device for playing audios and videos according to claim 4, wherein the video format conversion bridge chip is a bridge chip for converting HDMI into V-by-One, the data format of the first video format input interface is HDMI, and the data format of the second video format output interface is V-by-One.

7. The device for playing audios and videos according to claim 3, wherein the processor is coupled to the video format conversion bridge chip and the motion compensation frame rate converter respectively through an I2C bus.

8. The device for playing audios and videos according to claim 1, wherein the processor is coupled to an audio system through an I2S audio bus, and transmits audio signals in the decoded audio and video signals to the audio system.

9. The device for playing audios and videos according to claim 2, wherein the device for playing audios and videos is a TV set, the main signal source is a TV signal source, a signal source from internet or a signal source downloaded from a local end, and the external signal source is an audio and video signal source of a video and audio device externally connected to the device for playing audios and videos.

10. The device for playing audios and videos according to claim 1, wherein the processor is further coupled with one of Bluetooth, WIFI, Ethernet, a 2.4G communication module, a memory module and combinations thereof.

11. A method for playing audios and videos, comprising:
receiving audio and video signals, and decoding the audio and video signals;
converting video signals in the decoded audio and video signals into first data format video signals;
converting the first data format video signals into second data format video signals; and
displaying the second data format video signals.

12. The method according to claim 11, wherein the method, before the displaying the second data format video signals, further comprises:
processing the second data format video signals as high resolution and high frame rate video signals; and
and the displaying the second data format video signals comprises:
displaying the high resolution and high frame rate video signals.

13. The method according to claim 11, wherein the first data format is HDMI, and the second data format is V-by-One.

14. The method according to claim 11, further comprising:
playing audio signals in the decoded audio and video signals.

15. A non-transitory computer-readable storage medium storing executable instructions that, when executed by an electronic device with a touch-sensitive display, cause the electronic device to:
receive audio and video signals, and decode the audio and video signals;
convert video signals in the decoded audio and video signals into first data format video signals;
convert the first data format video signals into second data format video signals; and
display the second data format video signals.

16. The non-transitory computer-readable storage medium according to claim 15, wherein before the display the second data format video signals, the electronic device is further caused to:
process the second data format video signals as high resolution and high frame rate video signals; and
and the display the second data format video signals comprises:
display the high resolution and high frame rate video signals.

17. The non-transitory computer-readable storage medium according to claim 15, wherein the first data format is HDMI, and the second data format is V-by-One.

18. The non-transitory computer-readable storage medium according to claim 15, wherein the electronic device is further caused to:
play audio signals in the decoded audio and video signals.
